(19) United States
(12) Patent Application Publication
(10) Pub. No.: US 2003/0134260 A1
(43) Pub. Date: Jul. 17, 2003

(54) Multi-client type learning system

(76) Inventors: Richard M. Hartman, Santa Clara, CA (US); Kaushik C. Barde, Sunnyvale, CA (US); Gopinath R. Rebala, Sunnyvale, CA (US); John McCaughey, Mountain View, CA (US); Tin Pham, Palo Alto, CA (US); Murali Gowrisankaran, Sunnyvale, CA (US)

Correspondence Address: Robert P. Renke, Artz & Artz, P.C., Suite 250, 28333 Telegraph Road, Southfield, MI, 48034, US

(21) Appl. No.: 10/044,629

(22) Filed: Jan. 11, 2002

(51) Int. Cl. G09B 3/00

(52) U.S. Cl. 434/350

(57) ABSTRACT

A telecommunication control system for an interactive instruction network system is provided. The control system includes a presenter software interface displaying communication signals in a host compatible software language. A presentation server modifies the communication signals by performing a plurality of presenter chosen tasks via the presenter software interface. Two or more bi-directional client adapters convert communication signals between said host compatible software language and two or more heterogeneous client type compatible software languages. One or more Internet data adapter(s) direct the communication signals between the presenter software interface and the two or more heterogeneous client types via one or more Internet protocols. A method for performing the same is also provided as well as an interactive instruction network system and method.

### TECHNICAL FIELD

The present invention relates generally to educational learning systems, and more particularly, to a method and system for incorporating multiple mediums having various communicative transports and service providers within a single learning system.

### BACKGROUND OF THE INVENTION

Learning systems exist primarily within schools and businesses for educational purposes. Through the use of telecommunications, instructional classrooms are extended beyond traditional classrooms to remote locations. Live communication signals may be recorded from an instructor, in real-time and broadcast from a first location to several remote locations within a single Intranet, such as a local area network (LAN).

Existing learning systems have several advantages over traditional classrooms. Costs in renting a room within a facility to instruct a class, administration costs, and student transportation costs are significantly reduced. Classroom time and travel time to and from the classroom is also reduced. Many colleges, using learning systems, further decrease costs by synchronizing instruction time with a television station schedule. The television station bears the expense of studio and transmitter equipment and the software when a videotape is provided in a syndication. A student need only tune a television receiver into the television station to view the instructor.

Businesses typically use teleconferencing and teleinstuction techniques that are more elaborate than college based teleinstruction. Teleinstruction allows a special interest class to be convened and communicated across town, across country, or even around the world on a secure channel if needed. Businesses use two-way picture and sound communications that tend to be rather expensive. Special purpose video equipment and video grade channels are needed over and above ordinary telephone conferencing systems.

Traditional learning systems are limited in that not only are they Intranet based, thereby limiting instruction to a finite group, but also that they apply to only a specific client type contained within a specific college or business. These limitations reduce the number of individuals that can access the learning systems and reduce the number of possible locations that the learning systems can be accessed.

With an ever increasing number of various different medium types and a constant desire to provide easily accessible instruction, a need for a learning system that is more wide based and is able to satisfy multiple organizations and individuals having multiple media types exists.

### SUMMARY OF THE INVENTION

The present invention provides a method and apparatus for incorporating multiple mediums having various communicative transports and service providers within a single learning system. A telecommunication control system for an interactive instruction network system is provided. The telecommunication system includes a presenter software interface displaying communication signals in a host compatible software language. A presentation server modifies the communication signals by performing a plurality of presenter chosen tasks via the presenter software interface. Two or more bi-directional client adapters convert communication signals between the host compatible software language and two or more heterogeneous client type compatible software languages. One or more Internet data adapter(s) direct the communication signals between the presenter software interface and the two or more heterogeneous client types via one or more Internet protocols. A method for performing the same is also provided as well as an interactive instruction network system, referred to herein as a learning system, and method.

One of several advantages of the present invention is that it is adaptable to a range or a variety of bandwidth availabilities, thus allowing it to communicate between the host site and multiple client types, via the Internet.

Another advantage of the present invention is that it provides a learning system that is compatible with multiple client types on multiple Internet protocols. Therefore, allowing an individual to have easy access to the learning system in various remote locations.

Other advantages and features of the present invention will become apparent when viewed in light of the detailed description of the preferred embodiment when taken in conjunction with the attached drawings and appended claims.

### BRIEF DESCRIPTION OF THE DRAWINGS

FIG. 1 is a perspective view of an interactive instruction network system utilizing a telecommunication control system in accordance with an embodiment of the present invention;

FIG. 2 is a block diagrammatic view of various logic modules contained within a controller utilized by the interactive instruction network system in accordance with an embodiment of the present invention;

FIG. 3 is a block diagrammatic view of several logic modules contained within a telecommunication control system of the controller in accordance with an embodiment of the present invention;

FIG. 4 is a logic flow diagram illustrating a method of remote educational instruction over the interactive instruction network system in accordance with an embodiment of the present invention; and

FIG. 5 is a logic flow diagram illustrating a method of synchronizing and converting communication signals between a host controller and multiple client types in accordance with an embodiment of the present invention.

### DETAILED DESCRIPTION OF THE PREFERRED EMBODIMENT

While the present invention is described with respect to a method and apparatus for incorporating multiple mediums having various communicative transports and service providers within a single learning system, the present invention may be adapted and utilized by various organizations and private individuals including: educational organizations, public and private businesses, domestic or private individuals or organizations, or others desiring a remote learning capability.

In the following description, various operating parameters and components are described for one constructed embodiment. These specific parameters and components are included as examples and are not meant to be limiting.

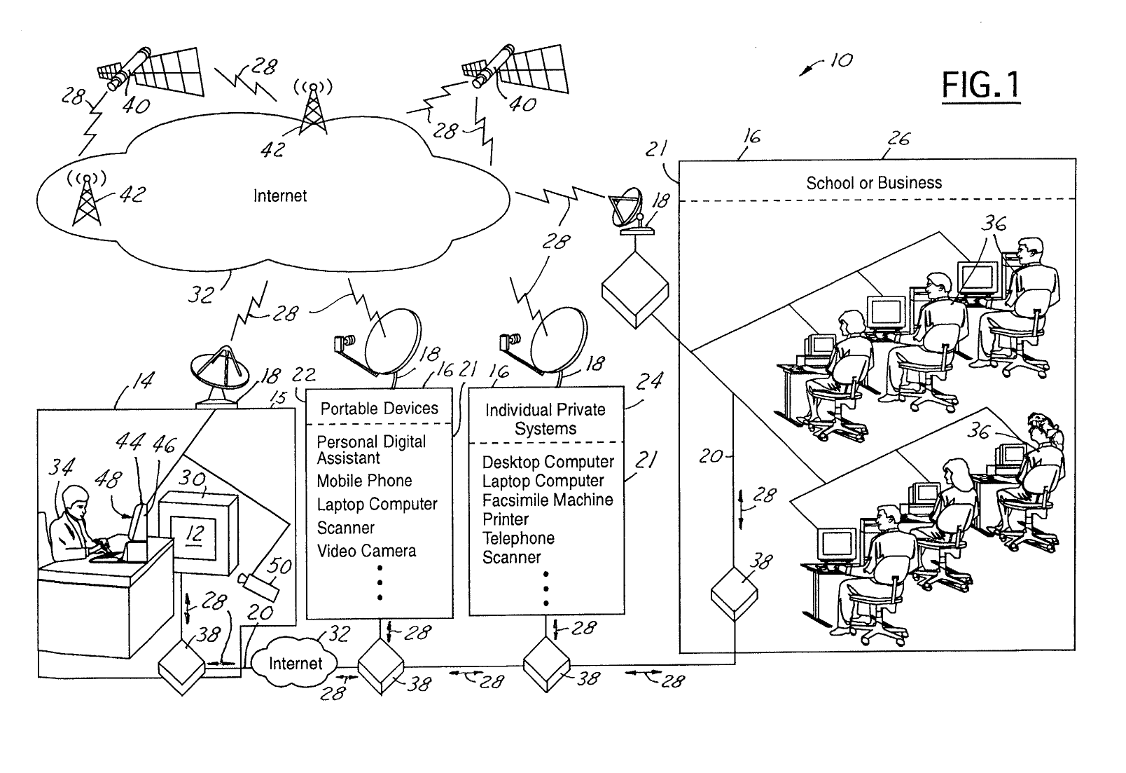

Referring now to FIG. 1, a perspective view of an interactive instruction network system 10 utilizing a telecommunication control system 12 in accordance with an embodiment of the present invention, is shown. The network system 10 includes a studio 14, at a host site 15, for recording and broadcasting communication signals to multiple heterogeneous client types 16 via ground stations 18 or by cable 20. The client types 16 are at various remote sites 21. Although, the client types 16 are divided into three main groups, portable devices 22, individual private systems 24, and school or business mediums 26, other client types may also be incorporated. Communication signals 28 are transmitted and received between a host controller 30 in the studio 14 and the client type 16 via a communication transport, such as an Internet 32. The communication signals 28 are transmitted in real-time. The communication signals may include: a presentation signal, an instruction signal, a client type signal, a response signal from either a presenter 34 or a student 36, video signals, audio signals, or various other communication signals. Number 36 represents all students accessing the system 10 not just school and business students, as illustrated. Various routers 38 are used to direct and signal condition the communication signals 28 having various Internet protocol (IP) between the Internet 32, the controller 30, and the client types 16. The communication signals 28 may be transmitted through satellites 40 or communication towers 42 to the various client types 16 or by the cable 20.

The studio 14 includes a presenter hardware interface 44 having a presenter terminal 46. The presenter terminal 46 may have a touch screen 48 for quick and easy manipulation of a presentation and response to the client types 16. The controller 30 is electrically coupled between a video camera 50 and the presenter interface 44 for video taping the presenter 34.

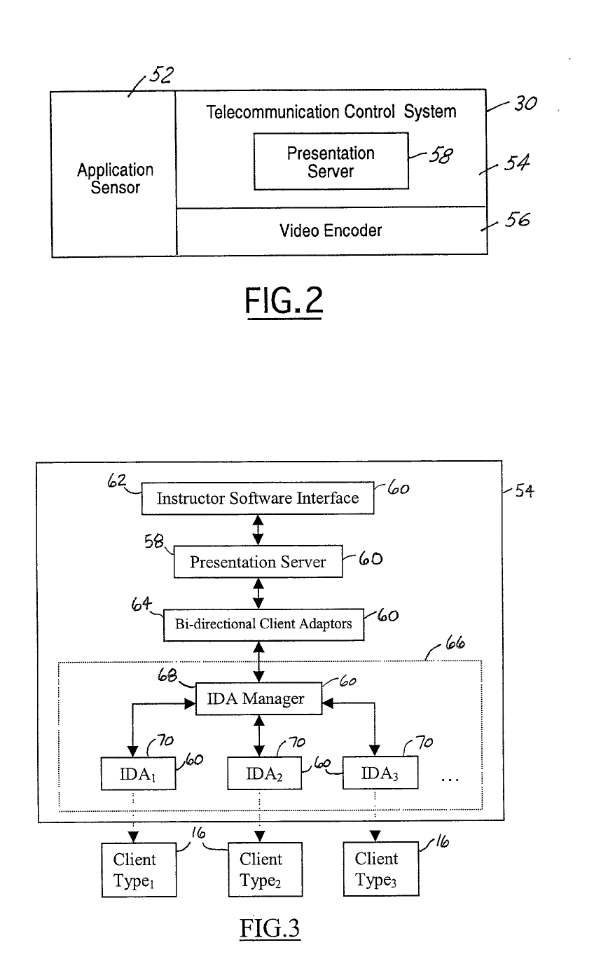

Referring now also to FIG. 2, a block diagrammatic view of logic modules within the controller 30 in accordance with the present invention, are shown. The controller 30 is divided into three main modules an application server 52, a telecommunication control system 54, and a video encoder 56. The application server 52 stores various applications, such as multiple presentations for different courses. The control system 54 performs various functions such as being a translator between a host software language and various client type languages, a signal director, an Internet protocol distinguisher, as well as several other functions further described herein below. The control system 54 includes a presentation server 58 that generates a presentation signal. The presentation server 58 is described in more detail below. The video encoder 56 converts video and audio signals, within the communication signals 28, into a digital format, which is transmitted to the client types 16.

The controller 30 may be microprocessor based such as a computer having a central processing unit, memory (RAM and/or ROM), and associated input and output buses. The controller 30 may be a stand-alone main control unit as shown or may be divided up into several units as to decrease the load on any one individual unit. For example, the controller 30 may be divided into a stand-alone application server, a stand-alone presentation server, and a stand-alone video encoder or be a server farm. The versatility and flexibility of the controller 30 lends itself well to many applications where the studio 14 is divided into several different rooms or possibly several different locations. The presenter 34 may be in a first room with the video camera 50 in a second room.

The client types 16 and the studio 14 may include any of the following: a microphone, a keyboard, a mouse, a video monitor, a LCD screen, a 7-segment display, a computer, a video camera, a cite control and keypad combination, a proprietary client type, or various other communication devices. The client types 16 may also have very small aperture terminal interfaces. The client types 16 may also be incorporated within an Intranet. The Intranet may be any of the following: a local area network, a wide area network, a direct television system, or other Intranet type network or system known in the art.

The portable devices 22 may include any one or any combination of the following: a personal digital assistant, a mobile phone, a laptop or desktop computer, a scanner, a video camera, or various other portable devices known in the art. Portable devices 22 may be located within an automotive vehicle, at a stationary location, or simply in a purse or a briefcase. Portable devices 22 may also be incorporated within a Bluetooth communication system, such as commonly used within a vehicle. Thereby, allowing an individual to easily access the system 10 at virtually any location using any known client type.

The individual private systems 24 may include any one or any combination of the following: a laptop or desktop computer, a facsimile machine, a printer, a telephone, a scanner, or various other private systems known in the art. Private systems 24 may be located within a residential home, a small private business, an organizational meeting hall, or various other locations.

Schools and businesses 26 having various types of Intranets that may utilize the present invention as to have a common interactive instruction network system. A single business may have multiple Intranets of different type. The present invention allows the different Intranets to be incorporated into a single interactive instruction network system, whereby a first student may sign in on a first Intranet system and register into the same course as a second student signed in on a second Intranet. The present invention permits an individual to access and view or listen to a course on any client type that has a communication transport connection to the system 10. In order to limit the accessibility the controller 30 may contain a security system to block accessibility to proprietary or confidential information.

Internet access within the system 10 provides the presenter 34 and the students 36 with a large number of information resources not normally available in traditional systems. The additional resources may be incorporated within interactive communication between the presenter 34 and the students 36.

Referring now to FIG. 3, a block diagrammatic view of several logic modules 60 contained within the control system 54 in accordance with an embodiment of the present invention, is shown. The control system 54 includes a presenter software interface 62, the presenter server 58, two or more bi-directional client adapters 64, and an Internet data adapter (IDA) complex 66.

The software interface 62 displays various windows or viewing screens. The windows and viewing screens may include: a window for viewing students 36, an interactive window including student questions and presenter answers, a testing window having multiple questions to be answered by students, a topic window displaying presenter illustrations or notes, or various other windows known in the art. Software interface 62 may also be world-wide-web browser based.

The presentation server 58 organizes the windows, timing of various sessions, and multiple other session oriented functions.

The two or more client adapters 64 convert the communication signals 28 between a host compatible language and two or more heterogeneous client type compatible languages. The host site 15, maintains a standard software language, being that it is a single site. The client types 16 however may be at various remote sites using multiple different software languages. Therefore, the adapters 64 are needed to convert software languages that are not normally compatible with the software language used by the host site 15.

The IDA complex 66 includes an IDA manager 68 and multiple IDAs 70. The IDA manager 68 controls transmission of the communication signals between the IDAs 70 and said adapter 64. An example of an IDA that may be used is the SERGE™ IDA, by DATACOM Corporation. Each IDA 70 directs the communication signals 28 between the host site 15 and the client types 16 via one or more Internet protocols (IPs). The IPs may include a multicast transport, a unicast transport, a transmission control protocol, a low bandwidth protocol, point-to-point protocol, a user datagram protocol, or other IPs known in the art.

A multicast transport has an advantage over a unicast transport in that multiple client types may be coupled to a single Internet protocol. The multicast protocol creates an artificial address where information is written. Client types 16 may than access the artificial address. The routers 38 need to be aware of any created artificial addresses to direct the client types 16.

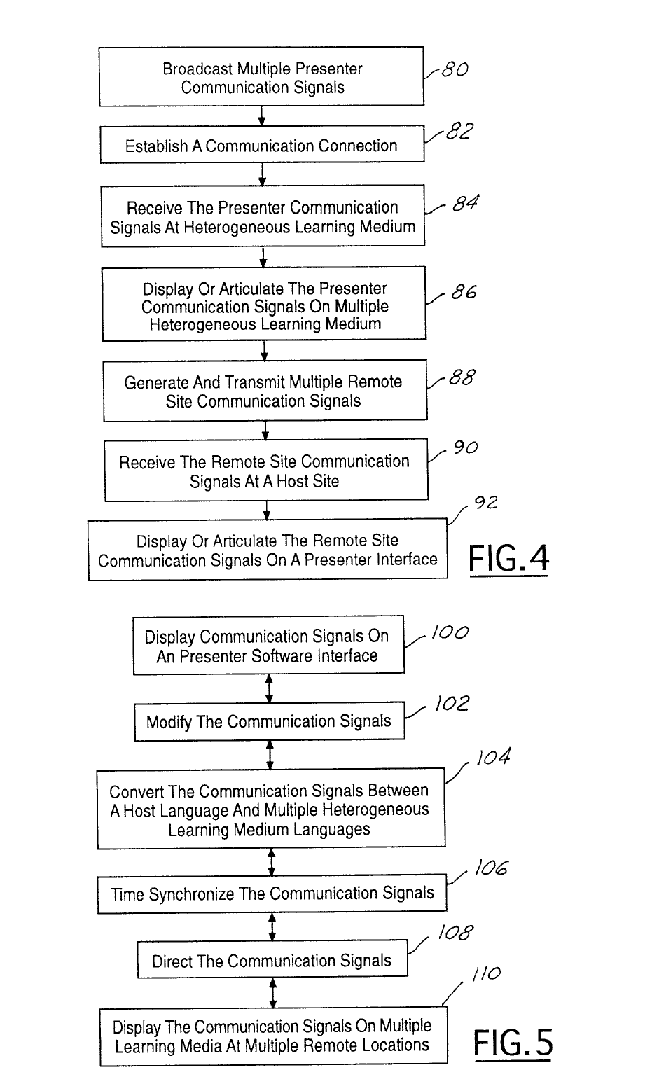

Referring now to FIG. 4, a logic flow diagram illustrating a method of remote educational instruction over the system 10 in accordance with an embodiment of the present invention is shown.

In step 80, the controller 30 broadcasts multiple presenter communication signals from the presenter 34 to the client types 16. The broadcast may be wireless via the satellites 40 or through cable 20 using a communication transport. The communication transport may be an Internet 32, as shown in FIG. 1, and stated above or may be another communication transport known in the art. The Internet 32 may be accessed by the controller 30 and the client types 16 through any of the following: a network service provider, a corporate modem bank, a digital subscriber line, a satellite network, a cable television network, or other Internet service provider device or system known in the art.

In step 82, the controller 30 establishes a communication connection between the host site 15 and the client types 16.

In step 84, the presenter communication signals, within the communication signals 28, are received by the client types 16.

In step 86, the presenter communication signals are displayed or articulated on the client types 16. Students 36 viewing or listening to the presenter communication signals may monitor the presentation, take a quiz or test, interact with the presenter by asking questions or sharing general thoughts, and perform various other tasks. A student at one client type may view statements from another student at a different client type. The presenter 34 has the ability to determine material displayed on each client type 16.

In step 88, the remote sites 21 generate and transmit multiple remote site communication signals to the host site 15.

In step 90, the host site 15 receives the remote site communication signals.

In step 92, the remote site communication signals are displayed on the presenter interface 44.

Note the order of the steps in FIG. 4 and in the following FIG. 5 are shown as examples, the steps may be performed in reverse order or in a different sequence depending upon a particular situation.

Referring not to FIG. 5, a logic flow diagram illustrating a method of synchronizing and converting the communication signals 28 between the controller 30 and the client types 16 in accordance with an embodiment of the present invention, is shown.

In step 100, the controller 30 displays communication signals 28 on the software interface 62.

In step 102, the communication signals 28 are modified by the presenter 34. The presenter 34 may modify the presentation or the material to be viewed on any one client type 16 via the presenter interfaces 44 and 62 and other communication devices available to the presenter 34 within the studio 14. In so doing the presenter server 58 modifies the communication signals 28 accordingly.

In step 104, the adapter 64 converts the communication signals 28 between the host language and the client type languages.

In step 106, the IDA manager 68 synchronizes in time the communication signals 28.

In step 108, the IDAs 70 direct the communication signals 28 between the general Internet protocol of the controller 30 and the multiple Internet protocols of the client types 16. The IDAs 70 act as a type of switchboard directing and redirecting the communication signals 28. When an additional client type is developed a new IDA is created to allow the controller 30 to transmit the communication signals 28 to the new client type.

The present invention therefore provides an interactive education learning system that is easily accessible on various different client types using multiple Internet protocols. A student or business associate may access a presentation using a client type that is available to that student or associate. The present invention is suitable for low bandwidth usage, thus allowing it to communicate between a host site and multiple client types, via the Internet.

While particular embodiments of the invention have been shown and described, numerous variations and alternate embodiments will occur to those skilled in the art. Accordingly, it is intended that the invention be limited only in terms of the appended claims.

What is claimed is:

1. A telecommunication control system for an interactive instruction network system comprising:
an presenter software interface displaying communication signals in a host compatible software language;
a presentation server modifying said communication signals by performing a plurality of presenter chosen tasks via said presenter software interface;
two or more bi-directional client adapters converting communication signals between said host compatible software language and two or more heterogeneous client type compatible software languages; and
one or more Internet data adapter(s) directing said communication signals between said presenter software interface and said two or more heterogeneous client types via one or more Internet protocols.

2. A system as in claim 1 wherein said communication signals comprise at least one of a presentation signal, an instruction signal, a client type signal, or a response signal.

3. A system as in claim 1 further comprising an Internet data adapter manager controlling transmission of said communication signals between said one or more Internet data adapters and said two or more bi-directional client adapters.

4. A system as in claim 1 wherein at least one of said Internet data adapters is a SERGE adapter.

5. A system as in claim 1 wherein said one or more Internet protocols comprise at least one of a multicast transport, a unicast transport, a transmission control protocol, a low bandwidth protocol, point-to-point protocol, or a user datagram protocol.

6. An interactive instruction network system comprising:
two or more of heterogeneous client types at two or more remote sites;
a host site comprising;
an presenter hardware interface for communicating with said two or more heterogeneous client types; and
a controller comprising a telecommunication control system and electrically coupled to said presenter hardware interface and transmitting a plurality of presenter communication signals; and
a high-speed data communication transport electrically coupled to said two or more heterogeneous client types and said host site, said high-speed data communication transport providing said two or more heterogeneous client types access to said plurality of presenter communication signals and communication between said host site and said two or more heterogeneous client types.

7. A system as in claim 6 wherein said communication transport is an Internet.

8. A system as in claim 7 wherein said Internet is accessed through at least one of an Internet service provider, a network service provider, a corporate modem bank, a digital subscriber line, a satellite system, or a cable television network.

9. A system as in claim 6 wherein said telecommunication control system comprises:
an presenter software interface displaying communication signals in a host compatible software language;
a presentation server modifying said communication signals by performing a plurality of presenter chosen tasks via said presenter software interface;
two or more bi-directional client adapters converting communication signals between said host compatible software language and two or more heterogeneous client type compatible languages; and
one or more Internet data adapter(s) directing said communication signals between said presenter software interface and said two or more heterogeneous client types via one or more Internet protocols.

10. A system as in claim 6 wherein a heterogeneous client type of said two or more client types is incorporated within an Intranet.

11. A system as in claim 6 wherein a heterogeneous client type of said two or more client types comprises a very small aperture terminal interface.

12. A system as in claim 6 wherein a heterogeneous client type of said two or more client types is incorporated within a Bluetooth network.

13. A system as in claim 6 wherein said two or more heterogeneous client types comprises two or more of a cellular phone, a computer, a personal digital assistant, a palm pilot, a scanner, a printer, a video camera, a telephone, or a facsimile machine.

14. A system as in claim 6 wherein a heterogeneous client type of said two or more client types comprises at least one of a microphone, a keyboard, a mouse, a video monitor, a LCD screen, a 7-segment display, or a computer.

15. A system as in claim 6 wherein:
a heterogeneous client type of said two or more client types comprises a video camera generating a remote site communication signal; and
wherein said host site receives said remote site communication signal via said telecommunication system.

16. A system as in claim 6 wherein a first client type is able to receive communication through said communication transport between said host site and a second client type.

17. A method of remote educational instruction over an interactive instruction network system comprising:
broadcasting a plurality of presenter communication signals of a presenter from a host site;
establishing a communication connection between said host site and two or more heterogeneous client type via a communication transport;
receiving said presenter communication signals on said two or more heterogeneous client types; and
displaying or articulating at least one of said presenter communication signals on said two or more heterogeneous client types.

18. A method as in claim 17 further comprising:
generating and transmitting a plurality of remote site communication signals; and
receiving said plurality of remote site communication signals on a presenter interface at said host site.

19. A method as in claim 17 further comprising receiving communication between said host site and a first client type at a first remote site by a second client type at a second remote site.

20. A method of synchronizing and converting communication signals between a controller and heterogeneous client types within an interactive instruction network system, said method comprising:
displaying communication signals on a presenter interface;
modifying said communicational signals;
converting said communication signals between a host language and two or more heterogeneous client type languages;
time synchronizing the communication signals; and
displaying the communication signals on multiple learning media at multiple remote locations.
